(19) United States
(12) Patent Application Publication
(10) Pub. No.: US 2025/0073811 A1
(43) Pub. Date: Mar. 6, 2025

(54) Optical System With Demagnifying Telescope For Additive Manufacturing

(71) Applicant: Seurat Technologies, Inc., Wilmington, MA (US)

(72) Inventors: Andrew J. Bayramian, Marblehead, MA (US); Susanne Kras, Chelmsford, MA (US)

(21) Appl. No.: 18/817,887

(22) Filed: Aug. 28, 2024

Related U.S. Application Data
(60) Provisional application No. 63/579,426, filed on Aug. 29, 2023.

(51) Int. Cl. B23K 26/06; B22F 10/28; B22F 12/00; B22F 12/41; B23K 26/342; B33Y 10/00; B33Y 30/00; G02B 23/02; G02B 26/10

(52) U.S. Cl. CPC B23K 26/0643; B22F 10/28; B22F 12/222; B22F 12/224; B22F 12/41; B23K 26/342; B33Y 10/00; B33Y 30/00; G02B 23/02; G02B 26/101

(57) ABSTRACT

A print engine of an additive manufacturing system can include a XY gantry mirror system arranged to receive and redirect a two dimensional laser image. An XY galvo mirror system can be arranged to receive and redirect the two dimensional laser image from the XY gantry mirror system toward multiple positions on a print bed following a print path. A first demagnifying telescope capable of forming an image is positioned between the XY gantry mirror system and the XY galvo mirror system and a second image relay telescope is positioned between the first demagnifying telescope and the XY galvo.

### RELATED APPLICATION

The present disclosure is part of a non-provisional patent application claiming the priority benefit of U.S. Patent Application No. 63/579,426, filed on Aug. 29, 2023, which is hereby incorporated by reference in its entirety.

### TECHNICAL FIELD

The present disclosure generally relates to a system and method for high throughput additive manufacturing. In one embodiment, high speed manufacturing is supported by use a demagnifying and relay telescopes.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known Powder Bed Fusion Additive Manufacturing (PBF-AM) uses one or more focused lasers to draw a pattern in a thin layer of powder by melting the powder and bonding it to the layer below to gradually form a 3D printed part. Powders can be plastic, metal, glass, ceramic, crystal, other meltable material, or a combination of meltable and unmeltable materials (i.e. plastic and wood or metal and ceramic).

Two dimensional laser images can be used to fuse and pattern a powder bed. Laser images can be redirected using XY gantry systems that support redirection optics. Unfortunately, corrective optics are needed to accurately pattern the powder bed can be expensive to manufacture and difficult to arrange. To improve print quality a system and method for reducing the number and expense of corrective optics used in conjunction with XY gantry systems is needed.

### SUMMARY

In some embodiments, a print engine of an additive manufacturing system can include an XY gantry mirror system arranged to receive and redirect a two dimensional laser image. An XY galvo mirror system can be arranged to receive and redirect the two dimensional laser image from the XY gantry mirror system toward multiple positions on a print bed following a print path. A first demagnifying telescope capable of forming an image is positioned between the XY gantry mirror system and the XY galvo mirror system and a second image relay telescope is positioned between the first demagnifying telescope and the XY galvo.

In some embodiments the first demagnifying telescope further comprises reflective optical elements.

In some embodiments the first demagnifying telescope further comprises transmissive optical elements.

In some embodiments the second image relay telescope further comprises reflective optical elements.

In some embodiments the second image relay telescope further comprises transmissive optical elements.

In some embodiments a motion control system for the XY gantry and XY galvo can support dynamic adjustment of cycle time.

In some embodiments the XY galvo mirror system further includes a X galvo mirror and a Y galvo mirror.

In some embodiments the print bed is a powder bed.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIGS. 1A and 1B respectively illustrate top and side view for an XY gantry supporting a XY galvo mirror;

FIG. 1C illustrates one embodiment of an optical relay system including a demagnifying telescope that uses lenses and image relay telescope using reflective optical elements;

FIG. 2A illustrates one embodiment of an optical image system formed from reflective optical elements;

FIG. 2B illustrates an optical relay system with images at least in part formed with light valves;

FIG. 2C illustrates an embodiment of an optical image system formed from transmissive optical elements;

FIG. 3 illustrates an additive manufacturing system able to provide one or two dimensional light beams to a print bed;

FIG. 4 illustrates a method of operating a print bed based additive manufacturing system able to provide one or two dimensional laser light beams; and

FIG. 5 additive manufacturing system that includes a switchyard system enabling use of multiple print beds and reuse of patterned two-dimensional energy.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

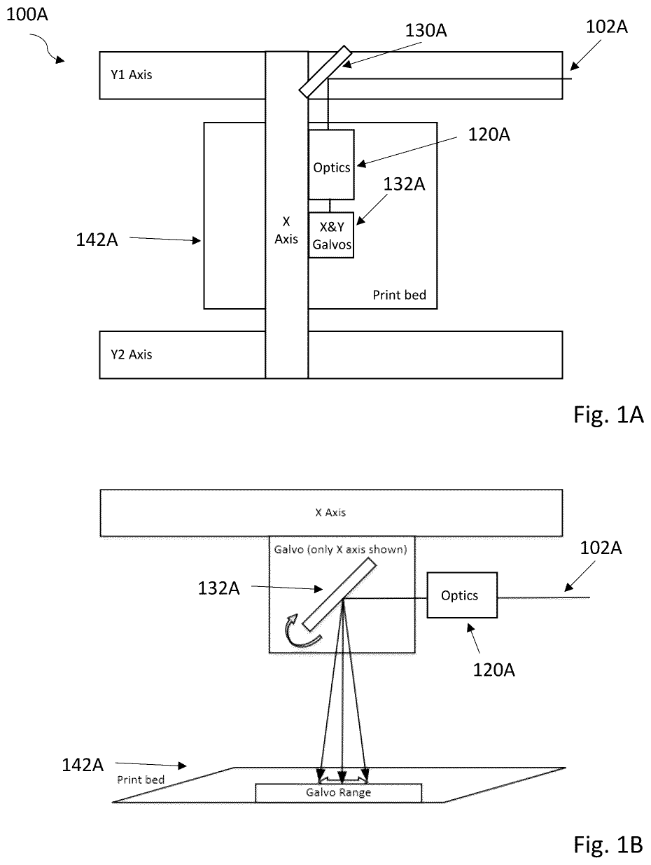

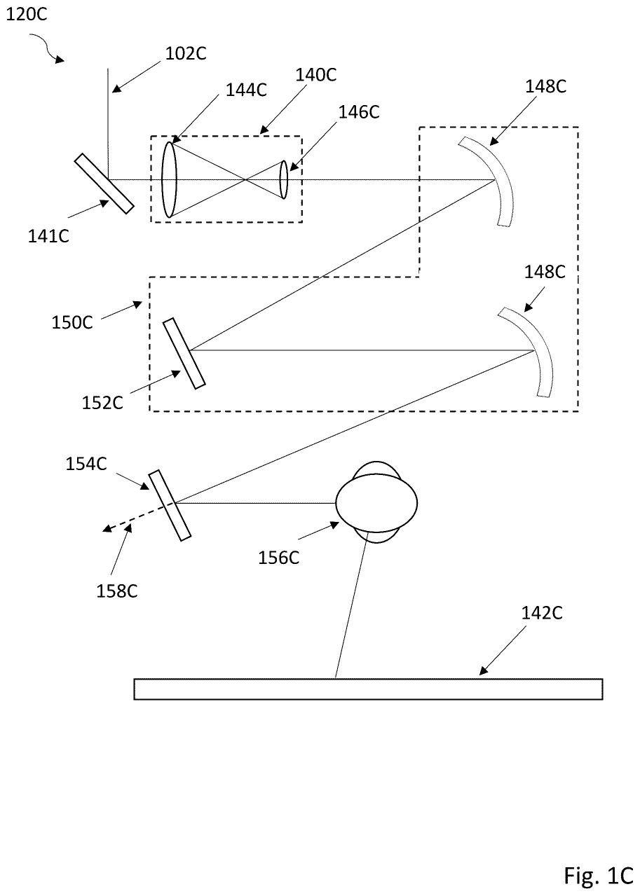

FIGS. 1A and 1B respectively illustrate top and side view for an XY gantry system 100A supporting a XY galvo mirror and various two dimensional image redirection or corrective optics. As seen in the Figures, a patterned or unpatterned laser image 102A can optionally be directed through various corrective or redirecting optical systems 120A. The laser image 102A can be directed by a fixed mirror 130A attached in a fixed position to the X gantry toward the optional corrective or redirecting optical systems 120A, then to the movable XY galvo mirror 132A, which in turn directs the laser beam toward a print bed 142A. Typically, the XY galvo mirror can be rotated 0.5 degrees in 5 milliseconds or less, which is much faster than XY gantry movement.

As seen with respect to FIG. 1C, in some embodiments, an imaging system for an XY gantry such as discussed with respect to FIGS. 1A and 1B can have various corrective or redirecting optical systems, including either or both of a demagnifying telescope or a relay telescope. For example, image system 120C illustrates arrangement of optics supportable by, or directable to an XY gantry (not shown). An incoming two-dimensional image 102C can be redirected by a mirror 141C into a demagnifying telescope 140C. The demagnifying telescope 140C can include at least two refractive lens elements indicated as lens 144C. In an example the first demagnifying lens element 144C can have a focal length F=400, and the second demagnifying lens element 146C can have a with focal length F=80. Demagnified images can be relayed by a telescope 150C that can include curved mirrors 148C and a fold mirror 152C. Images from the relay telescope 150C can then be redirected by a fixed partially transmissive fold mirror 154C towards the movable galvo mirrors 156C, which can then redirect the image to the print bed 142C. That portion of an image passing through partially transmissive mirror 154C (i.e. beam 158C) can be diagnostically monitored to allow for rapid adjustment of beam power, quality or other characteristics. The greater portion of the two-dimensional image is directed to fuse powder on a print bed 142C.

In some embodiments the imaging system 120C can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the first set of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror is substantially equivalent to the image distance. In some embodiments, images can be redirected by movable galvo mirrors, one or more movable mirrors associated with the XY gantry or other imaging system structures, or one or more fixed mirrors onto print bed. In effect, various mirror systems enable a quick change in the optical beam delivery size and intensity across locations of a build area for different materials while ensuring high availability of the system.

In some embodiments, the XY gantry supporting a XY galvo mirror and various two dimensional image redirection or corrective optics can be used in a tile print process. Such a tile print process can use suitable software computer aided design (CAD) files that provide necessary details regarding printable part parameters and metadata can be stored in a database accessible by an additive manufacturing printer. For example, in one process embodiment a part definition for printing in a chamber is selected. Using a recipe library, print parameters including tile parameters, powder type, or nominal laser parameters are assigned. A print job is scheduled and powder bed and optional cartridge system can be readied for printing. Once print is initiated, layers are processed to determine tiling parameters, including size and offset, with laser parameters set for compensating for supports or overhangs. A process print sequence algorithm, optionally including serpentine paths can be chosen and data streamed for job execution. Job execution can include spreading and inspecting a powder layer, receipt of tile bitmaps by projectors, receipt of tile positions by a motion controller, and receipt of tile laser parameters by a laser controller. During execution the DMC projectors are readied to display tiles, the laser controller prints the tile, and the motion controller moves between subsequent tile positions until completion of a print job. In some embodiments, each printed layer can be inspected and the Z-axis indexed for to the next layer.

In some embodiments, a tile print path can be based on a rectangular print bed divided into multiple tiles. Print path moves from a tile to tile, with tiling parameters such as tile size, tile offset, and width, various alternative print paths being supported. In some embodiments, a print path can be arranged at least in part according to the pattern that is to be printed and/or the number of tiles able to be managed by a galvo mirror system. In one embodiment, a serpentine path can be determined. Such a serpentine path can be modified based on which tiles need to be printed and which tiles do not need to be printed. In some embodiments, a serpentine path can be shifted to start at a first corner of a first tile to be printed. In other embodiments, the path can be dynamically adjusted to minimize motion between tiles, or hybrid serpentine paths can be determined to accommodate other process or thermal constraints (e.g. allowing longer rest times for certain tiles to cool). In some embodiments, those tiles that do not need to be printed can be skipped, advantageously reducing required mechanical movement of galvo gantries and galvo mirrors as compared to embodiments that move to each and every tile position during a conventional linear or serpentine path that moves to every potential tile position.

In some embodiments, tiling can be overlapping. Typically, overlap is a small fraction of tile size, and can be measured in microns to millimeters. In one embodiment, an x and a y offset with respect to an underlying layer are provided for a subsequent layer. In effect, this provides tile overlay and ensures that stitched seams do not overlap. In some embodiments, tile overlap can be set so that tiles can overlap in a same print layer, in addition to, or instead of, overlap between layers.

In some embodiments, a printer control system and laser control system can control laser timing during tile printing. As illustrated, streaming tile data for printing can be continuously supplied to a tile image projector, tile position motion controller, and a laser controller. In one embodiment, data streaming is structured so that the image projector and motion controller always have more queued data than the laser controller, ensuring that the image projector and motion controller have sufficient tile information to allow the laser controller to be triggered for upcoming tiles that need to be printed. In some embodiments, streaming is not real time, and requires buffering tile image projector, tile position motion controller, and a laser controller.

In some embodiments the printer control system passes data to the laser control system when a minimum amount of tile data is buffered. Light valve cycling and illumination can be configured, the motion controller moves optics and projector provides a display to illuminate a desired tile. Laser heating time is set, target site temperature measured, laser power set, and a pulse laser is enabled. The pulse laser can then be fired with various timing or shaping sequences as needed. In some embodiments cycle time can be adjusted to help avoid cycle skips.

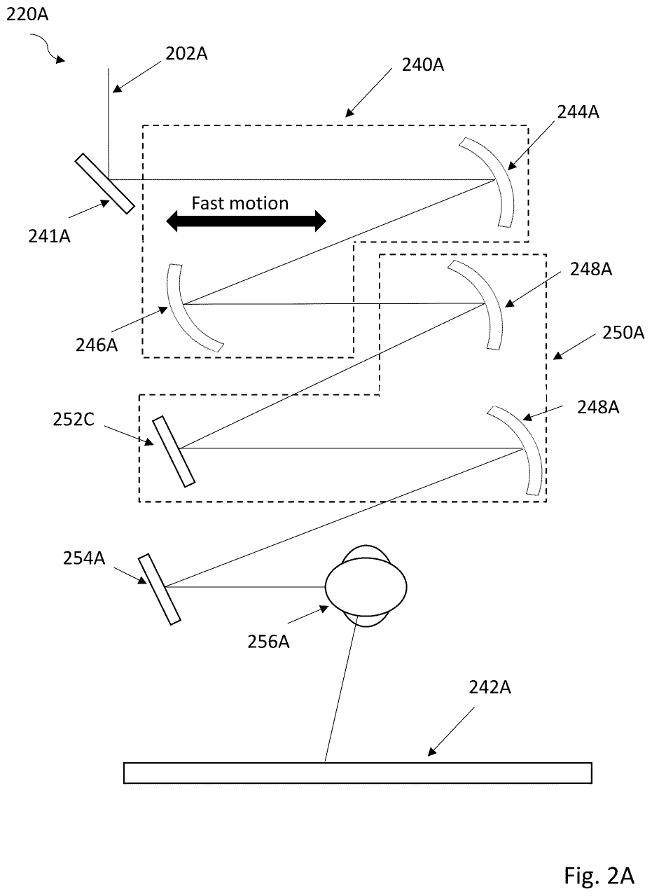

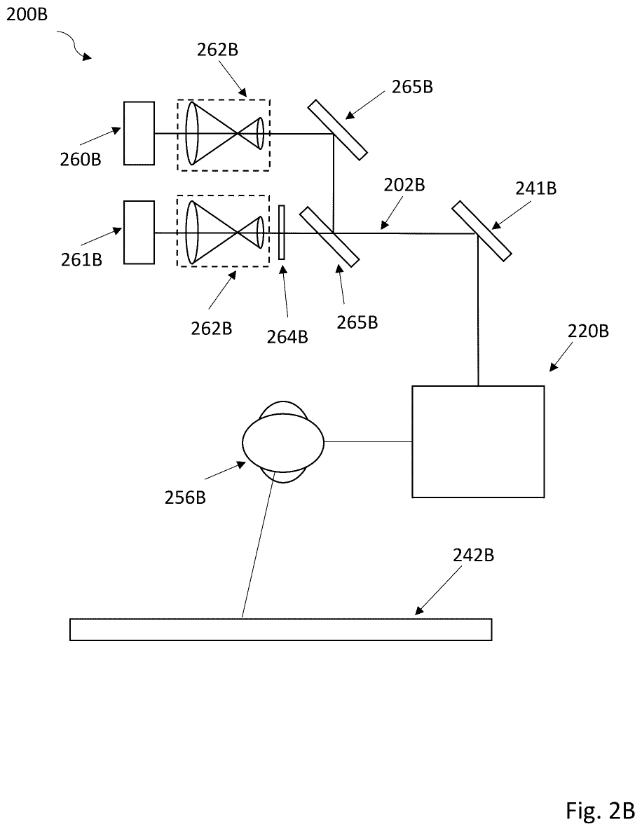

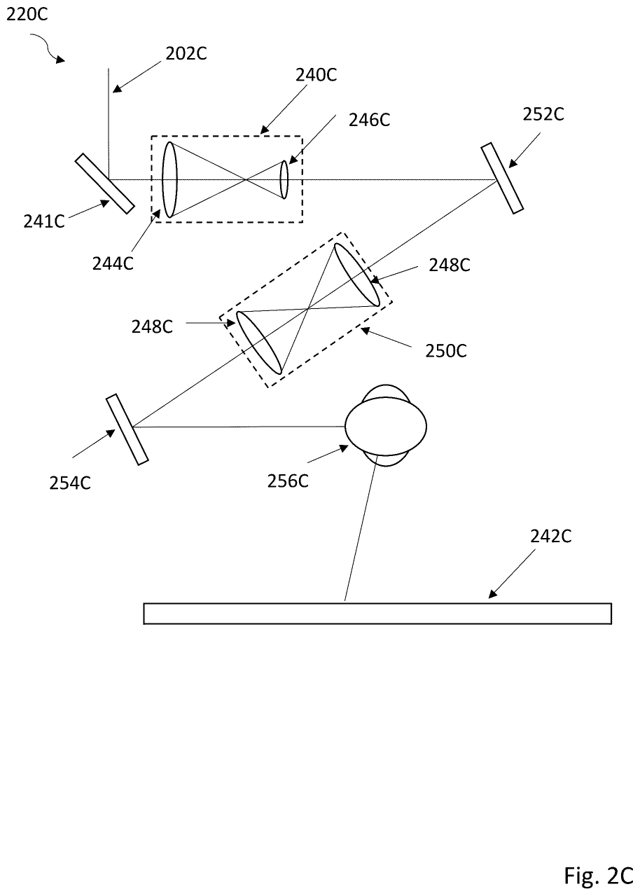

FIG. 2A illustrates one embodiment of an imaging system 220A completely formed from reflective optical elements. This imaging system 220A can be used in a two-dimension tile print process using an XY gantry (not shown) such as discussed with respect to FIGS. 1A and 1B. The imaging system can have various corrective or redirecting optical systems, including either or both of a demagnifying telescope 240A or a relay telescope 250A. For example, an incoming two-dimensional image 202A can be redirected by a mirror 241A into a demagnifying telescope 240A. The demagnifying telescope 240A can include various curved reflective optical elements such as 244A and 246A. Demagnifying telescope 240A can be dynamically shifted during printing to keep the final image focal plane at the print bed 242A as the pointing of the galvo mirrors 256A changes. Demagnified images can be relayed by a relay telescope 250A that can include various curved reflective optical elements 248A. Images can be redirected by movable galvo mirrors 256A and one or more fixed mirrors 254A onto print bed 242A. As will be appreciated, in some embodiments one or both demagnifying telescope 240A or a relay telescope 250A can be moved as needed to redirect images, or alternatively or in addition, single or multiple mirrors can used in conjunction with the demagnifying telescope 240A or a relay telescope 250A to direct images.

FIG. 2B illustrates an optical relay system with images at least in part formed with light valves. This imaging system 200B can be used in a two-dimension tile print process using an XY gantry (not shown) such as discussed with respect to FIGS. 1A and 1B. The imaging system can have various corrective or redirecting optical systems 220B. Identical images are imposed on the beams by light valves 260B. An optional telescope 262B after each light valve can demagnify the light valve images. An optical element to rotate polarization 264B changes the polarization of the beam from one of the light valves so that polarizers 265B can be used to combine the beams and overlay the images from each light valve. The combined two dimensional image 202B can be redirected by a mirror 241B into various corrective or redirecting optical systems 220B, and from there to the galvo mirrors 256B and the print bed 242B.

FIG. 2C illustrates another embodiment of an optical image system 200 where both the demagnifying telescope and the relay telescope include refractive lens elements. For example, optical image system 220C illustrates arrangement of optics supportable by, or directable to an XY gantry (not shown). An incoming two-dimensional image 202C can be redirected by a mirror 241C into a demagnifying telescope 240C. The demagnifying telescope 240C can include at least two refractive lens elements indicated as lens 244C and lens 246C. Demagnified images can be directed by mirror 252C to a relay telescope 250C that can include refractive lens elements 248C. Images can be redirected by movable galvo mirrors 256C, one or more movable mirrors associated with the XY gantry or other imaging system structures, or one or more fixed mirrors 254C onto print bed 242C.

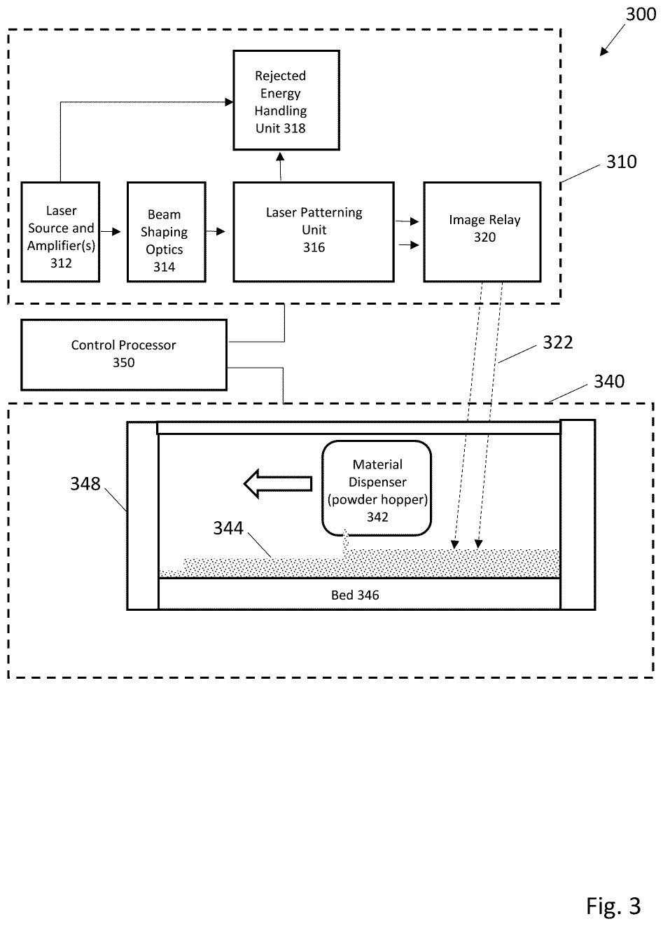

In an embodiment illustrated with respect to FIG. 3, additive manufacturing systems including the described optical system embodiments and telescopes can be represented by various modules that form additive manufacturing method and system 300 suitable for use in conjunction with tile printing process procedures that can optionally use an XY galvo gantry and galvo mirror system with a loop variable timer. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulse source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO₄) laser, Neodymium doped yttrium calcium oxoborate Nd:YCa4O(BO₃)3 or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium) aluminum fluoride (Ce:LiSAF, Ce:LiCAF), Promethium 147 doped phosphate glass (147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride (Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 3, the additive manufacturing system 300 uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by an energy patterning unit 316, with generally some energy being directed to a rejected energy handling unit 318. Patterned energy is relayed by image relay 320 toward an article processing unit 340, in one embodiment as a two-dimensional image 322 focused near a bed 346. The article processing unit 340 can include a cartridge such as previously discussed. The article processing unit 340 has plate or bed 346 (with walls 348) that together form a sealed cartridge chamber containing material 344 (e.g. a metal powder) dispensed by powder hopper or other material dispenser 342. Dispensed powder can be created or recycled as discussed in this disclosure. Patterned energy, directed by the image relay 320, can melt, fuse, sinter, amalgamate, change crystal structure, influence stress patterns, or otherwise chemically or physically modify the dispensed and distributed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroic) or diffractive elements. In other embodiments, multiple beams can be homogenized or combined using multifaceted mirrors, microlenses, and refractive or diffractive optical elements.

The laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 can be used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

Image relay 320 can receive a patterned image (either one or two-dimensional) from the laser patterning unit 316 directly or through a switchyard and guide it toward the article processing unit 340. The image relay can include telescope systems such as disclosed herein, as well as a range of other mirrors or optical elements.

The material dispenser 342 (e.g. powder hopper) in article processing unit 340 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2, C₄H₇, 1,3-C₄H₆, 1,2-C₄H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gases can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜ 0.1-0.2 cubic meters (i.e., greater than 100-200 liters or heavier than 500-1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that support a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having a article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that can be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to a variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

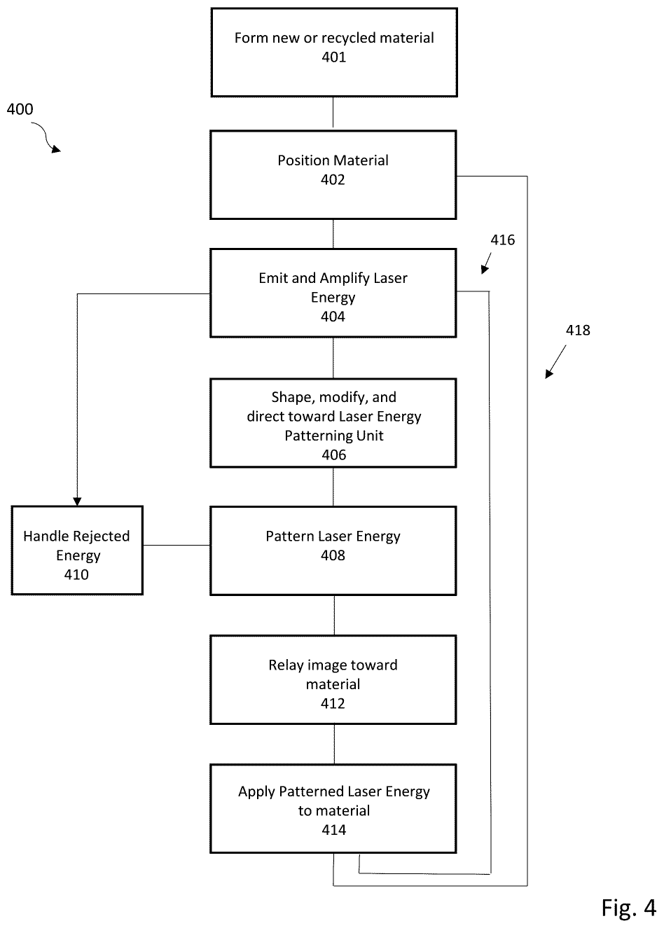

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

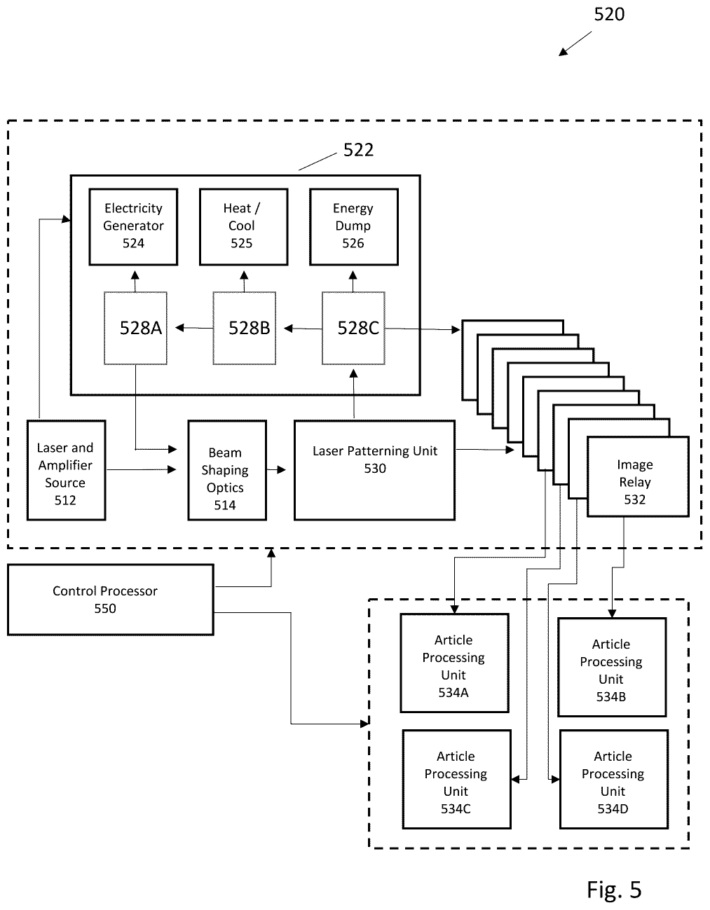

FIG. 5 is one embodiment of an additive manufacturing system that includes a light valve and a switchyard system enabling reuse of patterned two-dimensional energy. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials. In this embodiment, an additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed can optionally be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A print engine of an additive manufacturing system, comprising
a XY gantry mirror system arranged to receive and redirect a two dimensional laser image;
an XY galvo mirror system arranged to receive and redirect the two dimensional laser image from the XY gantry mirror system toward multiple positions on a print bed following a print path;
a first demagnifying telescope capable of forming an image and positioned between the XY gantry mirror system and the XY galvo mirror system; and
a second image relay telescope positioned between the first demagnifying telescope and the XY galvo.

2. The print engine of the additive manufacturing system of claim 1, wherein the first demagnifying telescope further comprises reflective optical elements.

3. The print engine of the additive manufacturing system of claim 1, wherein the first demagnifying telescope further comprises transmissive optical elements.

4. The print engine of the additive manufacturing system of claim 1, wherein the second image relay telescope further comprises reflective optical elements.

5. The print engine of the additive manufacturing system of claim 1, wherein the second image relay telescope further comprises transmissive optical elements.

6. The print engine of the additive manufacturing system of claim 1, further comprising a motion control system for the XY gantry and XY galvo that supports dynamic adjustment of cycle time.

7. The print engine of the additive manufacturing system of claim 1, wherein the XY galvo mirror system further comprises an X galvo mirror and a Y galvo mirror.

8. The print engine of the additive manufacturing system of claim 1, wherein the print bed is a powder bed.

9. A method for operating a print engine of an additive manufacturing system, comprising:
positioning a XY gantry mirror system to receive and redirect a two dimensional laser image;
positioning an XY galvo mirror system to receive and redirect the two dimensional laser image from the XY gantry mirror system toward multiple positions on a print bed following a print path;
forming an image with a first demagnifying telescope positioned between the XY gantry mirror system and the XY galvo mirror system; and
relaying a second image using a second image relay telescope positioned between the first demagnifying telescope and the XY galvo.

10. The method for operating a print engine of an additive manufacturing system of claim 9, wherein the first demagnifying telescope further comprises reflective optical elements.

11. The method for operating a print engine of an additive manufacturing system of claim 9, wherein the first demagnifying telescope further comprises transmissive optical elements.

12. The method for operating a print engine of an additive manufacturing system of claim 9, wherein the second image relay telescope further comprises reflective optical elements.

13. The method for operating a print engine of an additive manufacturing system of claim 9, wherein the second image relay telescope further comprises transmissive optical elements.

14. The method for operating a print engine of an additive manufacturing system of claim 9, further comprising use of a motion control system for the XY gantry and XY galvo that supports dynamic adjustment of cycle time.

15. The method for operating a print engine of an additive manufacturing system of claim 9, wherein the XY galvo mirror system further comprises a X galvo mirror and a Y galvo mirror.

16. The method for operating a print engine of an additive manufacturing system of claim 9, wherein the print bed is a powder bed.

17. A laser directing mirror system, comprising
a XY gantry mirror system arranged to receive and redirect a two dimensional laser image;
an XY galvo mirror system arranged to receive and redirect the two dimensional laser image from the XY gantry mirror system toward multiple positions;
a first demagnifying telescope capable of forming an image and positioned between the XY gantry mirror system and the XY galvo mirror system; and
a second image relay telescope positioned between the first demagnifying telescope and the XY galvo.

18. The laser directing mirror system of claim 17, wherein the first demagnifying telescope further comprises reflective optical elements.

19. The laser directing mirror system of claim 17, wherein the first demagnifying telescope further comprises transmissive optical elements.

20. The laser directing mirror system of claim 17, wherein the second image relay telescope further comprises reflective optical elements.

21. The laser directing mirror system of claim 17, wherein the second image relay telescope further comprises transmissive optical elements.

22. The laser directing mirror system of claim 17, further comprising a motion control system for the XY gantry and XY galvo that supports dynamic adjustment of cycle time.
